(19) United States
(12) Patent Application Publication
(10) Pub. No.: US 2019/0298595 A1
(43) Pub. Date: Oct. 3, 2019

(54) WHEELCHAIR SYSTEM AND METHOD OF USE

(71) Applicant: Charles Ramon Hutchins, Lapeer, MI (US)

(72) Inventor: Charles Ramon Hutchins, Lapeer, MI (US)

(21) Appl. No.: 16/242,076

(22) Filed: Jan. 8, 2019

Related U.S. Application Data
(60) Provisional application No. 62/648,729, filed on Mar. 27, 2018.

(51) Int. Cl. A61G 5/10

(52) U.S. Cl. CPC A61G 5/1059; A61G 5/14

(57) ABSTRACT

A wheelchair system enables a person with limited mobility to quickly and efficiently adjust their height with respect to objects near them such as tables, counters or vehicles. The wheelchair system uses a lifting device such as a jack, to elevate the seat of the wheelchair. The person is thus enabled to adjust their height.

### BACKGROUND

### 1. Field of the Invention

The present invention relates generally to mobility systems, and more specifically, to a wheelchair system for elevating and lowering a person sitting in the seat thereof.

### 2. Description of Related Art

Mobility systems are well known in the art and are effective means to enable those with limited physical capabilities to move about. For example, conventional wheelchairs have two large wheels and two small wheels attached to a frame that also supports a seat and a back. During use, a person sits in the seat and uses their hands and arms to rotate the large wheels causing the wheelchair to move about.

One of the problems commonly associated with a wheelchair is its limited use. For example, tables, counters and the like are fixed and the person in the wheelchair must use these common surfaces despite that there exists a mismatch between the surface and the person such as the table is too high to reach or too low to fit under.

Additionally, entering a van or other vehicle with a fixed roof is limited be the total height of the person in the wheelchair, resulting in their exit from the chair or their inability to use the vehicle without renovations thereto.

Accordingly, although great strides have been made in the area of wheelchairs, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a rear perspective view of a wheelchair system in accordance with a preferred embodiment of the present application;

FIGS. 2A and 2B are back views of the system of FIG. 2; and

FIG. 3 is a flowchart of the preferred method of use of the system of FIG. 1.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional wheelchairs. Specifically, the invention of the present application enables the adjustment of the height of a person in a wheelchair with respect to other objects such as tables or counters. In addition, the invention facilitates the entry and exit of a person in a wheelchair to a vehicle such as a van. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

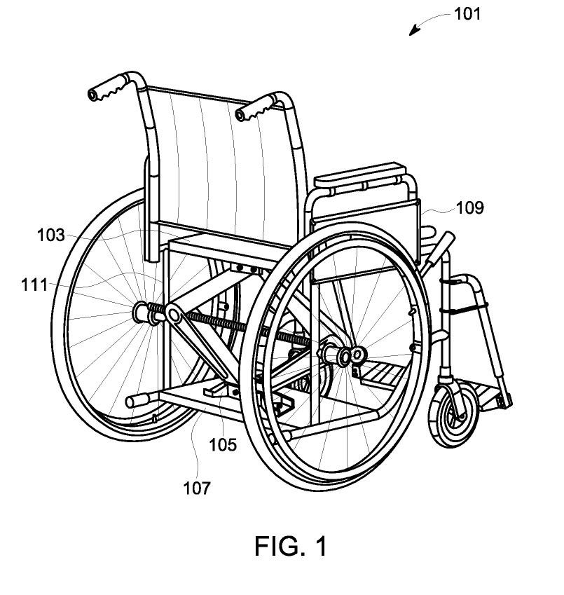

Referring now to the drawings wherein like reference characters identify corresponding or similar elements throughout the several views, FIG. 1 depicts a rear perspective view of a wheelchair system in accordance with a preferred embodiment of the present application. It will be appreciated that system 101 overcomes one or more of the above-listed problems commonly associated with conventional wheelchairs.

In the contemplated embodiment, system 101 includes a wheelchair 109 having a lift device 105 attached below the seat 103 and a support 107. The support 107 is rigidly attached to the wheelchair 109 and is contemplated to be any method of vertically moving the seat 103 wish such devices as a scissor jack, hydraulic jack, motors or the like. The seat 103 is slidingly attached to the wheelchair 109 via frame 111.

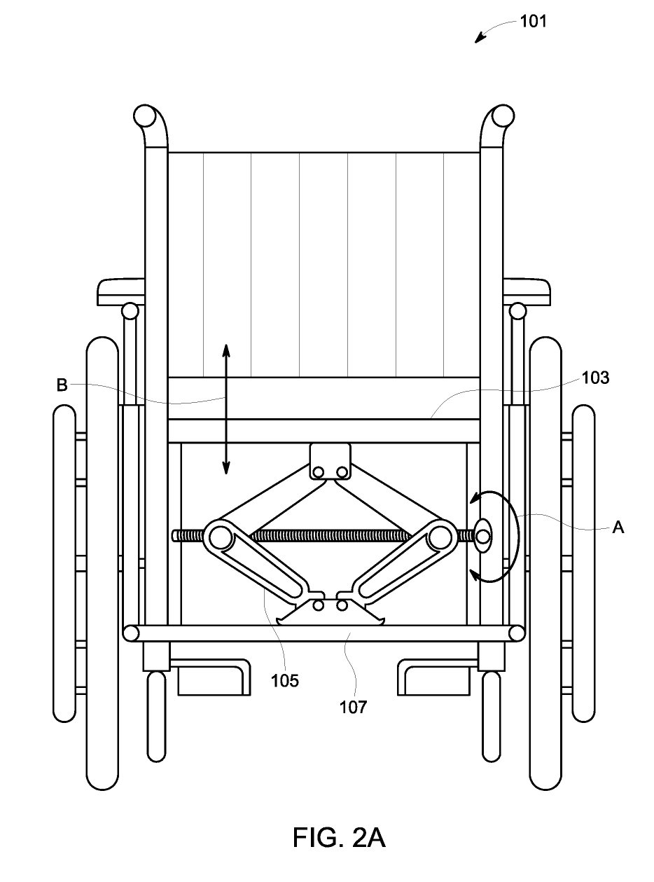

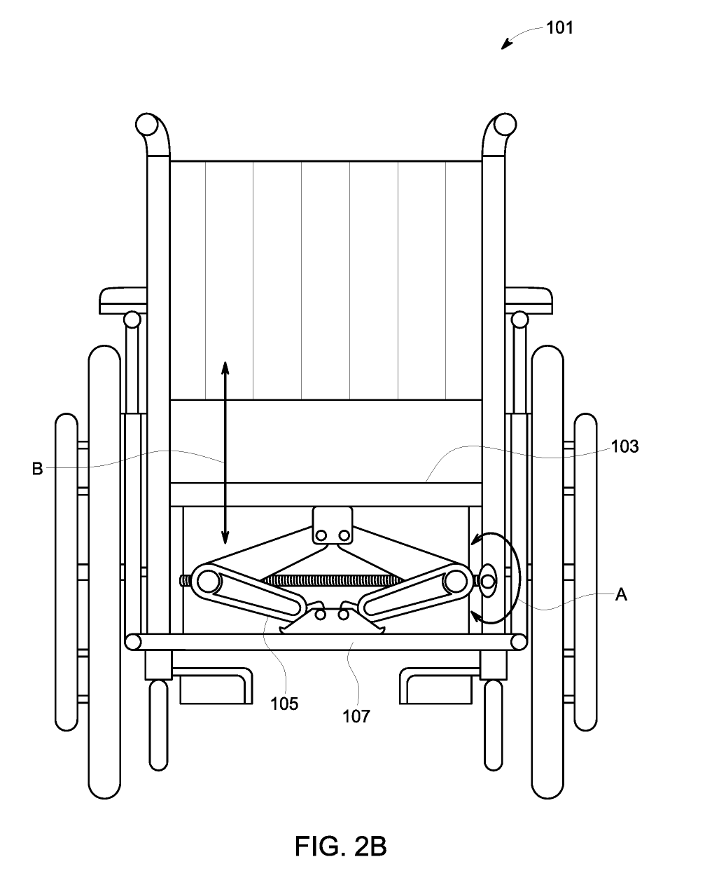

Referring now to FIGS. 2A and 2B the system 101 is shown in use. The activator 201 of the lift device 105 is rotated as depicted by motion A, causing the seat 103 to lower as depicted by motion B. The seat 103 rises by the reverse process just described.

It should be appreciated that one of the unique features believed characteristic of the present application is that the lift device 105 enables the change in height of the seat with respect to the remainder of the wheelchair 101. It will further be appreciated that the change in height of the seat will enable the use of vehicles that have not been altered to accommodate the extra space that a person in a in wheelchair normal uses. Additionally, the need to remove the person from the chair to use the unaltered vehicle will be reduced or eliminated.

It is also contemplated and will be appreciated that the height of the seat could be lowered sufficiently to allow the person in the wheelchair 101 to touch the ground or retrieve an object thereon.

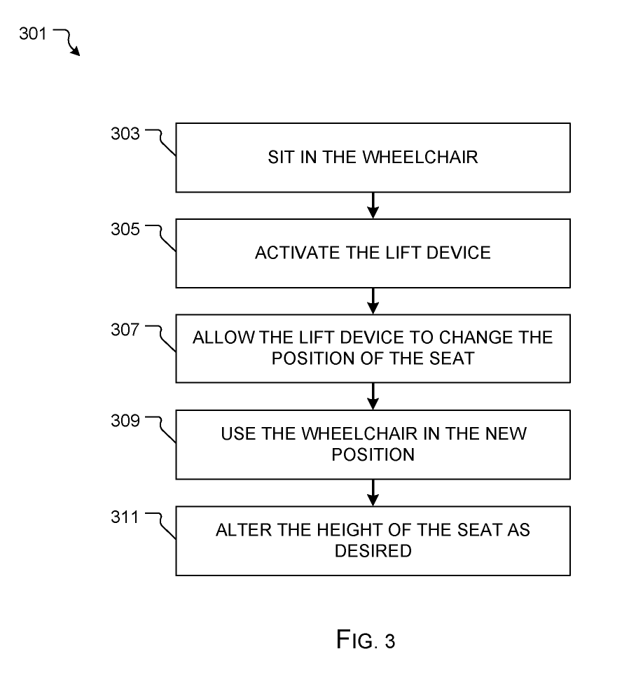

Referring now to FIG. 3 the preferred method of use of the system 101 is depicted. Method 301 includes sitting in a wheelchair 303, activating the lift device 305, allowing the lift device to change the position of the seat 307, using the wheelchair in the new position 309 and altering the height of the seat as desired 311.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

1. A wheelchair system comprising:
a wheelchair having:
a seat platform with a seat secured thereto;
a bottom support;
a plurality of vertical frames rigidly secured to and protruding from a top surface of the bottom support; and
a plurality of wheels secured to the plurality of vertical frames;
wherein the seat platform slidingly engages on the plurality of vertical frames;
a lift device secured to the seat platform and the bottom support of the wheelchair;
wherein the lift device changes the position of the seat with respect to the wheelchair in a vertical direction relative to the bottom support.

2. The system of claim 1 wherein the lift device is a scissor jack.

3. A method, comprising:
providing the system of claim 1;
sitting in a wheelchair;
activating the lift device;
allowing the lift device to change the position of the seat relative to the bottom support;
using the wheelchair in the new position; and
altering the height of the seat as desired.
